(19) United States
(12) Patent Application Publication
(10) Pub. No.: US 2005/0020303 A1
(43) Pub. Date: Jan. 27, 2005

(54) Mobile electronic device with integrated stylus input device

(76) Inventor: Steven Sunyuen Chan, Fremont, CA (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 10/844,771

(22) Filed: May 12, 2004

Related U.S. Application Data
(60) Provisional application No. 60/469,906, filed on May 12, 2003.

(51) Int. Cl. H04M 1/00

(52) U.S. Cl. 455/556.1

(57) ABSTRACT

A mobile communication device including an integrated stylus input unit to input data into the device, and an interface to wirelessly transmit data. In one embodiment, the integrated stylus is a handwriting stylus input device to input data by moving the stylus over a substantially flat surface. In one embodiment, the stylus includes a motion sensor embedded in an antenna extending from the device.

This application claims priority to related provisional patent application No. 60/469,906 filed May 12, 2003 titled “Mobile Device With Integral Electronic Pen Device For Input” (Attorney Docket No. 6109.P002z) and is herein incorporated by reference.

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention generally relates to the mobile electronic devices. More particularly, an embodiment of the present invention relates to a mobile electronic device having an integrated stylus input.

### BACKGROUND

FIG. 1 shows a typical mobile electronic device such as cell phone 100. Device 100 is, however, not limited to being a cell phone. It may be a personal digital assistant (PDA), an MP-3 player, a digital camera, or any kind of a multitude of small, mobile personal electronic devices or combinations thereof currently available or available in the future. A cell phone is used as an example of current technology because it is widely available and popularly used.

Cell phone 100 has an antenna 101, a main body 102, a display 103, and a keyboard 104. Also normally present are connectors 105 for input/output and power. Often there is a removable battery pack or other power source (not shown), or other, device-specific features, such as a built-in camera, etc.

FIG. 2 shows a pen 200 that has, in addition to the main body 201 with a writing tip 204, also a motion detection system 202 that allows motion of the pen to be tracked and recorded. Writing tip 204 in this example rests on writing surface 203.

However, in using a phone or any other kind of small, mobile personal electronic device for retention and transmission of text data, character input remains a problem. A variety of different approaches are known in current art, such as, for example, the inclusion of a stylus with a PDA, or addition of a small portable keyboard; or even alphanumeric input via a telephone keypad. All these approaches as known in current art have the underlying problem of being inconvenient and cumbersome in comparison to use of a full-sized keyboard or simple manual notations (i.e., handwriting) on a standard writing surface, such as a piece of paper. More recently, a pen as shown in FIG. 2 has been offered as a separate mobile device, but it requires docking to a computer for uploading and downloading data. Such devices are suitable, for example, for taking notes, but require a PC for uploading data for further processing, typically via a docking station or similar data exchange mechanism.

What is clearly needed is an apparatus and method that, by integrating a portable electronics device such as a phone with an electronic pen, can be used to generate text character input into the phone, for the purposes of, for example, emailing a text message comprising a short note, etc.

### BRIEF DESCRIPTION OF THE DRAWINGS

The invention is illustrated by way of example and not limitation in the figures of the accompanying drawings, in which like references indicate similar or identical elements, and in which:

FIG. 1 illustrates a typical mobile electronic device;

FIG. 2 illustrates a pen and motion detection system;

FIG. 3 illustrates a hand held a writing tool;

FIG. 4 illustrates a mobile device with an integrated stylus input device, in accordance with one embodiment;

FIG. 5 illustrates a block diagram of a mobile device with an integrated stylus input device, in accordance with one embodiment; and

FIG. 6 illustrates a flow diagram of method for using mobile device with an integrated stylus input device, in accordance with one embodiment.

### DESCRIPTION OF THE EMBODIMENT

In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

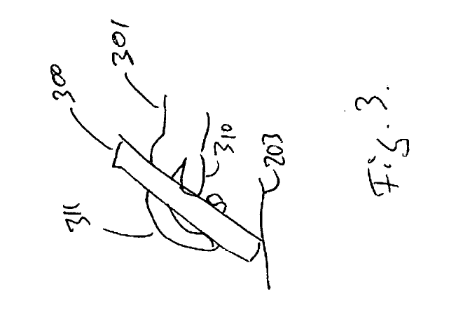

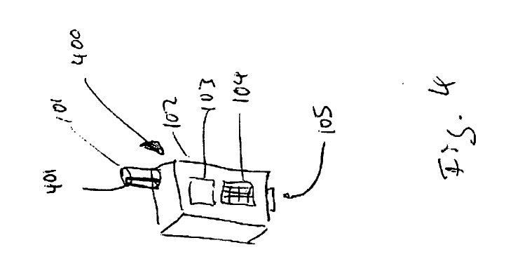

FIG. 3 shows a hand 301 holding a writing tool 300 of extra large size. In typical fashion, the writing tool 300 is held in an opposed-thumb manner. Thumb 310 and forefinger 311 grab the tool where the back of the shaft rests on the bridge between thumb and forefinger. The other fingers are in the back in a supporting role. The tip of the writing tool touches writing surface 203.

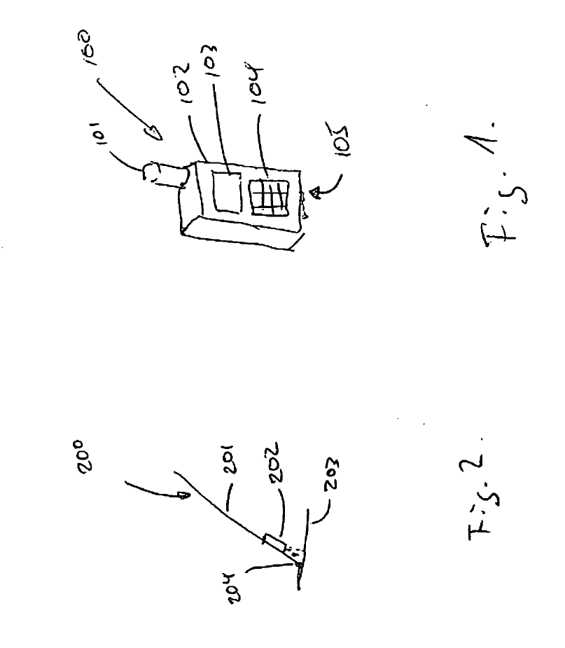

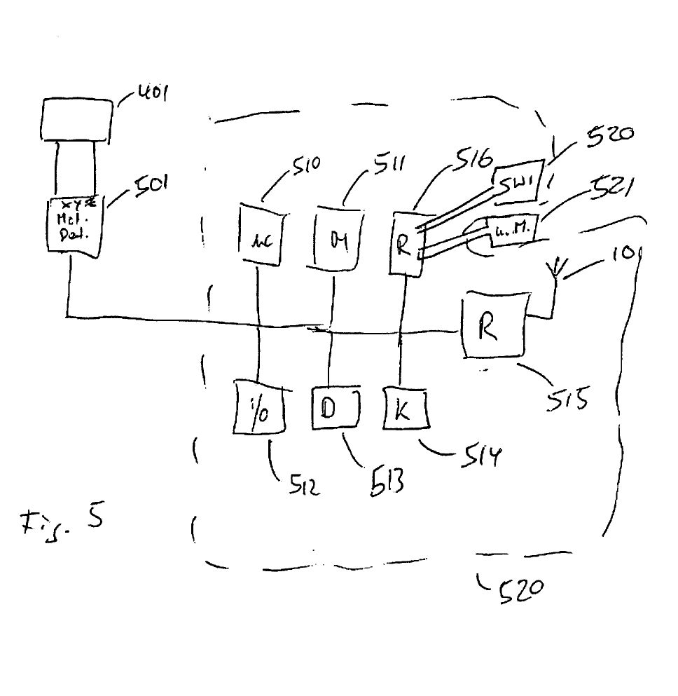

Rather than using just a pen, such as device 300, a cell phone 400, as shown in FIG. 4, may be used, in accordance with one embodiment. The user would hold it like a writing instrument, but would place a part of the cell phone with an embedded sensor tip, for example, one embedded in antenna 101, on a sheet of paper or other reasonably flat surface such as the back of one's hand, and use it as a writing tip similar to that of aforementioned device 204 in FIG. 2. In addition to the features of a standard cell phone described in FIG. 1, device 400 now also has a motion sensor 401, added, for example, at the antenna. This sensor 401 may be a motion sensor based on pure motion, or it may be an optical sensor as is used in so-called advanced optical mice (which do not require a special surface, or it may be a combination of both types, or a track ball, or an optical sensor using special surfaces with preprinted X and Y grids in different colors, or those using a camera to detect absolute motion in a relatively small area. In any of these cases, using any one or a combination of those sensor types, the writing motion of the user can now be detected and analyzed.

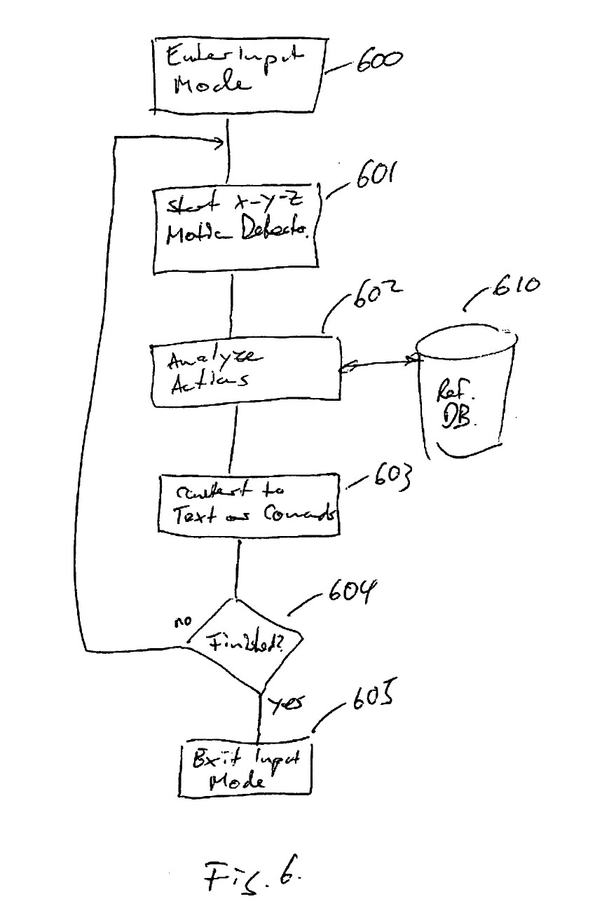

FIG. 5 shows a simplified overview of such a system for detection and analysis of handwriting motion, in accordance with one embodiment. Block 401 represents the motion sensor unit, which could be any of the sensor types described in the explanation of FIG. 4, above. It could contain, for example, two gyroscopes, or it could contain any kind of optical or other sensors that allow motion tracking. Unit 501 then converts the sensor signals to X, Y, and Z motions. The Z motions may indicate when the user makes vertical motions of the pen such as, for example, lifting the pen from the paper or setting it back down onto the paper, or as an added refinement to measure stylus pressure, to detect the end of characters, the start of characters, to insert punctuation, etc. Depending on the technology implemented, it may be in some cases just a simple interface, and it also may be implemented partially in software, with a varying degree of partitioning between software and hardware, or between different software modules.

Also shown is microcontroller 510, memory 511 and ROM 516, which is typically a flash ROM or a combination of fixed ROM and flash ROM, containing the phone operating software 520 and some special software 521 for interface to unit 501. Also shown is radio 515, keyboard 514, display 513, and IR interface 512. Not shown is the power supply. Although in many cases phones may have more than one microcontroller and may have substantially more complex structure than is shown in FIG. 5, the area within the dotted line 520 is representative of a “standard phone” of the type that, with many wide variations of features, may be available in the market today.

FIG. 6 illustrates a flow diagram of method for using mobile device with an integrated stylus input device, in accordance with one embodiment. The user may, for example, decide to send to another user a message of the type well known in the art as an “instant message.” When the phone prompts the user for input, such as a name or the actual text, input mode commences in process 600. In process 601, the motion detector starts, then the motion sequences are analyzed in process 602 and compared to reference database 610. The results of said analysis is converted in process 603 into text or commands as appropriate within the context of the phone system. In process 604, after each motion-conversion sequence, the system checks whether the user is finished. If the user is not finished, the system loops back to process 601. If the user is finished, input mode is exited at process 605. To determine whether the user is finished or not, the system may look for any of a variety of signals from the user. Such an exit signal may be, for example, a simple keystroke at a standard keyboard, a special button located on the phone, a sequence of buttons pushed on a telephone keypad, or a special sign painted with the phone, such as a code script, or a special sign, as is known in the art of handwriting input and CAD input devices, on the writing surface. Some or all of the processes of FIG. 6 need not be performed with the phone itself, but rather, may be performed on a server in the network cloud (not shown), and the result may be transmitted to the phone. For example, the X, Y Z motion sequence could be recorded and transmitted to said server, which could be much more powerful in analyzing the motions and sending the results back to the phone.

In yet other cases, the X, Y, Z motion may be captured as a graphic file, such as a GIF, JPEG, or other standard or proprietary graphics or binary data (i.e., motion points as a chain) file type, and transmitted to a server cooperating with it; in particular, motions such as drawing speed, relative direction, pen acceleration, and stylus pressure can be sequentially recorded to form a digital sequence that can be encoded to uniquely identify the handwritten signature of a user for purposes of providing user authentication. Also, in cases of an image file, colors may be offered in a special input mode, using, for example, numeric keys on the phone keyboard in some instances, or a command character or code sign, to activate and select colors as an auxiliary means. For example, numbers one through nine may each be assigned a color, with zero as no color; i.e., an eraser.

The processes described above can be stored in a memory of a mobile electronic device as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in them selves recite only those features regarded as essential to the invention.

1. A mobile communication device comprising:
an integrated stylus input unit to input data into the device; and
an interface to wirelessly transmit data.

2. The mobile communication device of claim 1 wherein the integrated stylus is a handwriting stylus input device to input data by moving the stylus over a substantially flat surface.

3. The mobile communication device of claim 2, wherein the stylus includes a motion sensor embedded in an antenna extending from the device.

4. The mobile communication device of claim 1, wherein the device is selected from a group comprising of a cell phone, a personal digital assistant, a digital camera, and an MP3 player.

5. The mobile communication device of claim 3, wherein the motion sensor includes an optical sensor.

6. The mobile communication device of claim 3 wherein the motion sensor includes a track ball.

7. The mobile communication device of claim 3 wherein the stylus is configured to be positioned between a thumb and a forefinger of a user when the stylus is being used to input data into the device.

8. The mobile communication device of claim 2, wherein the motion sensor detects motion in three separate directions including horizontal, perpendicular, and vertical relative to the surface.

9. The mobile communication device of claim 3 wherein the motion sensor is to detect motion in three separate axes relative to the surface, including an X axis, a Y axis, and a Z axis.

10. The mobile communication device of claim 9 wherein the motion sensor is to detect stylus pressure relative to the surface to detect an initiation of drawing a character or completion of drawing a character.

11. A method comprising of:
inputting data into a handheld electronic computing device via a stylus integrated on the handheld electronic computing device.

12. The method of claim 11, further including transmitting data wirelessly from the device.

13. The method of claim 12, further including detecting motion of the stylus and comparing the motion to a database of characters to identify a character being drawn by the stylus.

14. The method of claim 13, further including converting at least one character drawn with the stylus into text or a command.

15. The method of claim 11, wherein the device is selected from a group comprising of a cell phone, a personal digital assistant, a digital phone, and an MP3 player.

16. The method of claim 13, wherein the detecting motion of the stylus includes a motion sensor embedded in an antenna extending from the device, detecting motion of the stylus.

17. A machine-accessible medium that provides instructions that, if executed by a machine will cause said machine to perform operations comprising of:
inputting data into a handheld electronic computing device via a stylus integrated on the handheld electronic computing device.

18. The machine-readable medium of claim 17, further including transmitting data wirelessly from the device.

19. The machine-readable medium of claim 12, further including detecting motion of the stylus and comparing the motion to a database of characters to identify a character being drawn by the stylus.

20. The machine-readable medium of claim 19, further including converting at least one character drawn with the stylus into text or a command.
